(19) United States
(12) Patent Application Publication
(10) Pub. No.: US 2026/0252860 A1
(43) Pub. Date: Aug. 27, 2026

(54) PLANT IDENTIFICATION METHOD AND RELATED DEVICE

(71) Applicant: Hangzhou Ruisheng Software Co., Ltd., Zhejiang (CN)

(72) Inventors: Qingsong Xu, Zhejiang (CN); Tao He, Zhejiang (CN)

(73) Assignee: Hangzhou Ruisheng Software Co., Ltd., Zhejiang (CN)

(21) Appl. No.: 19/461,501

(22) Filed: Jan. 27, 2026

(30) Foreign Application Priority Data
Feb. 25, 2025 (CN) 202510213405.1

(51) Int. Cl. G06N 3/0475; G06N 3/08

(52) U.S. Cl. CPC G06N 3/0475; G06N 3/08

(57) ABSTRACT

Disclosed are a plant identification method and related devices. A plant identification method includes: obtaining a plant image and a question text about identifying a plant in the plant image; inputting the plant image and the question text into a plant knowledge question-answering model, the plant knowledge question-answering model including a visual model configured to receive the plant image to extract image features of the plant image, and a large language model configured to receive the image features and the question text to identify the plant in the plant image, the large language model is provided for further pre-training using a synthesized corpus generated based on a plant domain corpus on the basis of being pre-trained, the plant knowledge question-answering model is trained using multimodal data; and outputting an answer text about identifying the plant in the plant image provided by the plant knowledge question-answering model.

### CROSS-REFERENCE TO RELATED APPLICATION

This application claims the priority benefit of China application serial no. 202510213405.1, filed on Feb. 25, 2025. The entirety of the above-mentioned patent application is hereby incorporated by reference herein and made a part of this specification.

### BACKGROUND

### Technical Field

The present disclosure relates to information processing technology, and more specifically, to a plant identification method, an electronic device, a non-transitory storage medium and a computer program product, and also to a maintenance system.

### Description of Related Art

Currently, there are various applications (APPs) for plant identification, such as those specifically designed for identifying plants. These applications generally receive images and queries from user inputs and utilize identification models established based on artificial intelligence technology to identify objects within the images to obtain answers to the queries. The answers are then presented to the user on a user interface.

### SUMMARY

A brief overview of the present disclosure is given below to provide a basic understanding of some aspects of the present disclosure. However, it should be understood that this overview is not an exhaustive overview of the present disclosure. It is not intended to identify key or important parts of the present disclosure, nor is it intended to limit the scope of the present disclosure. Its purpose is merely to present some concepts of the present disclosure in a simplified form as a prelude to the more detailed description that is presented later.

According to a first aspect of the present disclosure, a plant identification method is provided, including: obtaining a plant image and a question text about identifying a plant in the plant image; inputting the plant image and the question text to a plant knowledge question-answering model, the plant knowledge question-answering model including a visual model and a large language model, wherein the visual model is configured to receive the plant image to extract image features of the plant image, the large language model is configured to receive the image features and the question text to identify the plant in the plant image, the large language model is provided for further pre-training using a synthesized corpus generated based on a plant domain corpus on the basis of being pre-trained, the plant knowledge question-answering model is trained using multimodal data, the multimodal data comprises plant images, questions about identifying the plant in the plant image, and answers to the questions; and outputting an answer text about identifying the plant in the plant image provided by the plant knowledge question-answering model.

In some embodiments, the synthesized corpus includes a mix of plant domain corpus data and synthesized corpus data.

In some embodiments, the synthesized corpus includes a mix of general domain corpus data and the synthesized corpus data.

In some embodiments, the quantity of the general domain corpus data is in a preset ratio to the quantity of the synthesized corpus data, and the preset ratio is determined via the following operations: training the large language model using the general domain corpus data and the synthesized corpus data mixed according to different ratios respectively as training data, and using validation data to determine a validation loss of the trained large language model; and selecting a ratio from the different ratios as the preset ratio based on the validation loss.

In some embodiments, the synthesized corpus is constructed via the following operations: segmenting plant domain corpus data in the plant domain corpus into one or more segments according to semantics; for each segment of the one or more segments, by using a language model, extracting an entity in the segment to obtain an entity collection, extracting interrelationships between the entities in each type of entity subset in the entity collection based on the segment, and generating synthesized corpus data from the segment based on the extracted entities and/or the interrelationships between the entities.

In some embodiments, generating the synthesized corpus data from the segment based on the extracted entities and/or the interrelationships between the entities includes at least one of the following: for each type of the entity subset in the entity collection, generating a rewritten content of the segment with each of the entities respectively in the entity subset as a focus to serve as the synthesized corpus data; or for each type of the entity subsets in the entity collection, generating an analysis content about an interaction of each of the entities in the entity subset in a context of the segment to serve as the synthesized corpus data.

In some embodiments, for each segment of the one or more segments, a summary and a title of the segment are also generated via the language model, and wherein at least one of the rewritten content and the analysis content is generated based on at least one of the summary and the title.

In some embodiments, the quantity of the entities included in each of the entity subsets is two or three.

In some embodiments, the entities include one or more of plant types, symptoms, diseases, and causes of the diseases.

In some embodiments, the visual model is a contrastive language-image pre-training (CLIP) model, and the CLIP model is trained on an image-text pair dataset through contrastive learning.

In some embodiments, the CLIP model is first trained separately using the image-text pair dataset via contrastive learning, and then jointly trained with the multimodal data together with the large language model that has undergone the pre-training and the further pre-training.

In some embodiments, the image-text pair dataset includes plant domain image-text pairs and general domain image-text pairs, and the quantity of the plant domain image-text pairs is in a preset ratio to the quantity of the general domain image-text pairs.

In some embodiments, the obtained question text includes question text about identifying a type of the plant in the plant image. The multimodal data includes plant images, questions inquiring about the type of the plant in the plant images, and answers indicating the type of the plant in the plant images. The plant domain image-text pair includes at least one of a pair consisting of the plant image and a Latin name of the plant, and a pair consisting of the plant image and a plant feature tag collection.

In some embodiments, the obtained question text includes question text about identifying a disease of the plant in the plant image. The multimodal data includes plant images, questions inquiring about the disease of the plant in the plant images, and answers indicating the disease of the plant in the plant images. The plant domain image-text pair includes at least one of a pair consisting of the plant image and a plant disease name, and a pair consisting of the plant image and a disease feature tag collection.

In some embodiments, the answer text includes the disease of the plant, and the answer text further includes one or more of causes of the disease, treatment methods for the disease, and maintenance suggestions for the plant.

In some embodiments, the plant identification method includes: generating a maintenance plan based on the answer text, wherein the maintenance plan includes one or more pairs, each pair of the one or more pairs includes one or more maintenance tasks and an identifier of a maintenance device for executing the one or more maintenance tasks; and outputting the maintenance plan.

In some embodiments, the plant identification method includes: controlling the corresponding maintenance device to complete the one or more maintenance tasks in the pair based on the identifier of the maintenance device in each pair of the one or more pairs in the maintenance plan.

According to a second aspect of the present disclosure, an electronic device is provided, including: a processor; and a memory storing computer-executable instructions. The computer-executable instructions, when executed by the processor, enable the processor to execute the plant identification method according to any embodiment in the first aspect of the present disclosure.

According to a third aspect of the present disclosure, a non-transitory storage medium having computer-executable instructions stored therein is provided, wherein the computer-executable instructions, when executed by a computer, enable the computer to execute the plant identification method according to any embodiment in the first aspect of the present disclosure.

According to a fourth aspect of the present disclosure, a computer program product is provided, wherein the computer program product includes instructions, the instructions, when executed by a processor, implement the plant identification method according to any embodiment in the first aspect of the present disclosure.

According to a fifth aspect of the present disclosure, a maintenance system is provided, including: an electronic device, wherein the electronic device includes a processor and a memory coupled to the processor and storing instructions. The instructions, when executed by the processor, enable the processor to: obtain a plant image and a question text about identifying a plant in a plant image; input the plant image and the question text to a plant knowledge question-answering model, the plant knowledge question-answering model including a visual model and a large language model, wherein the visual model is configured to receive the plant image to extract image features of the plant image, the large language model is configured to receive the image features and the question text to identify the plant in the plant image, the large language model is provided for further pre-training using a synthesized corpus generated based on a plant domain corpus on the basis of being pre-trained, the plant knowledge question-answering model is trained using multimodal data, the multimodal data includes plant images, questions about identifying the plant in the plant images, and answers to the questions; generate an answer text about identifying the plant in the plant image provided by the plant knowledge question-answering model; generate a maintenance plan based on the answer text, the maintenance plan including one or more pairs, each pair of the one or more pairs including one or more maintenance tasks and an identifier of a maintenance device for executing the one or more maintenance tasks, and transmit a command to the corresponding maintenance device according to the identifier of the maintenance device in each pair of the one or more pairs in the maintenance plan to control the corresponding maintenance device to complete the one or more maintenance tasks in the pair. The maintenance device communicatively coupled to the electronic device is also included, and the maintenance device is configured to execute the maintenance task in response to receiving the command from the electronic device.

In some embodiments, the maintenance system includes: a camera communicatively coupled with the electronic device, the camera being configured to capture the plant image and transmit the captured plant image to the electronic device, wherein the instructions include instructions that, when executed by the processor, enable the processor to execute the following operations: outputting the answer text based on the plant image received from the camera and a default question text about identifying the plant in the plant image.

In some embodiments, the default question text includes question text about identifying the type and/or the disease of the plant in the plant image.

### BRIEF DESCRIPTION OF THE DRAWINGS

From the following description of embodiments of the present disclosure shown in conjunction with the accompanying drawings, the foregoing and other features and advantages of the present disclosure will become clear. The accompanying drawings are incorporated herein and form a part of the specification, further serving to explain the principles of the present disclosure and enable those skilled in the art to make and use the present disclosure.

FIG. 1 shows a flowchart of a plant identification method according to some embodiments of the present disclosure.

FIG. 2 shows a schematic block diagram of a plant knowledge question-answering model according to some embodiments of the present disclosure.

FIG. 3 shows a schematic diagram of an exemplary user interface in which a plant identification method according to some embodiments of the present disclosure is applied.

FIG. 4 shows a flowchart of operations for generating a synthesized corpus according to some embodiments of the present disclosure.

FIG. 5 shows a non-limiting example process of generating synthesized corpus data based on plant domain corpus data according to some embodiments of the present disclosure.

FIG. 6 shows a schematic block diagram of an electronic device according to some embodiments of the present disclosure.

FIG. 7 shows a schematic block diagram of a computer system on which embodiments of the present disclosure may be implemented.

FIG. 8 shows a schematic block diagram of a maintenance system according to some embodiments of the present disclosure.

Note that in the embodiments described below, the same reference numerals are sometimes used in common among different drawings to indicate the same parts or parts having the same function, and repeated description thereof is omitted. In some cases, similar numerals and letters are used to indicate similar items, therefore, once an item is defined in a drawing, it does not need to be further discussed in subsequent drawings.

For ease of understanding, the position, size, range, etc. of each structure shown in the drawings and the like may not represent the actual position, size, range, etc. Therefore, the present disclosure is not limited to the position, size, range, etc. disclosed in the drawings and the like.

### DESCRIPTION OF THE EMBODIMENTS

Various exemplary embodiments of the present disclosure will be described in detail below with reference to the accompanying drawings. It should be noted that: unless otherwise specifically stated, the relative arrangement of components and steps, numerical expressions and numerical values set forth in these embodiments do not limit the scope of the present disclosure.

The following description of at least one exemplary embodiment is merely illustrative in nature and is in no way intended as any limitation to the present disclosure and its application or use. That is to say, the structures and methods herein are shown in an exemplary manner to illustrate different embodiments of the structures and methods in the present disclosure. However, those skilled in the art will understand that they merely illustrate exemplary ways in which the present disclosure may be implemented, rather than exhaustive ways. In addition, the drawings are not necessarily drawn to scale, and some features may be enlarged to show details of specific components.

In addition, techniques, methods and devices known to those of ordinary skill in the relevant field may not be discussed in detail, but in appropriate circumstances, such techniques, methods and devices should be considered as part of the specification.

In all examples shown and discussed herein, any specific values should be interpreted as merely exemplary, and not as limitations. Therefore, other examples of exemplary embodiments may have different values.

A Multimodal Large Language Model (MLLM) is a large neural network model that combines multiple different modal data such as text and images. This model may not only process text information, but may also simultaneously process other types of data, such as images, audio, etc. By simultaneously learning the correlations between multiple modal data, the multimodal large language model may more comprehensively understand and express information.

In order to provide more professional understanding and suggestions about plant identification, plant maintenance, and pest and disease diagnosis and treatment, the multimodal large language model needs to have sufficient relevant knowledge in the plant domain. Therefore, in order to strengthen the knowledge reserve of the multimodal large language model in the plant domain, the pre-trained multimodal large language model may be pre-trained on the plant domain corpus, thereby improving the performance of the pre-trained multimodal large language model in the plant domain.

However, multimodal large language models exhibit relatively low efficiency in acquiring knowledge from large-scale, unstructured general corpora. These models require numerous textual instances with varying expressions (for example, the growth characteristics of a specific type of plant) to learn a specific knowledge point. In the plant domain corpus, many textual instances appear only once or very infrequently. Consequently, continuing pre-training of multimodal large language models on a smaller-scale plant domain corpus, in comparison to a general corpus, presents significant challenges.

To this end, the present disclosure provides a plant identification method, which utilizes a plant knowledge question-answering model combining a large language model and a visual model, and may automatically process plant images and related questions to provide answers. The large language model in the plant knowledge question-answering model adopted in the present disclosure is pre-trained using a synthesized corpus generated based on a plant domain corpus. Since the large language model is subjected to further pre-training using a larger-scale and more diversified synthesized corpus generated based on the plant domain corpus, the large language model performs better in the plant domain, thereby improving the performance of the plant knowledge question-answering model in the plant domain and improving the user experience.

The plant identification method according to the present disclosure will be described in detail below with reference to the accompanying drawings. It should be understood that the actual plant identification method may also include other additional steps, but in order not to shift away from the focus of the present disclosure, these other additional steps are not discussed herein and are not shown in the drawings.

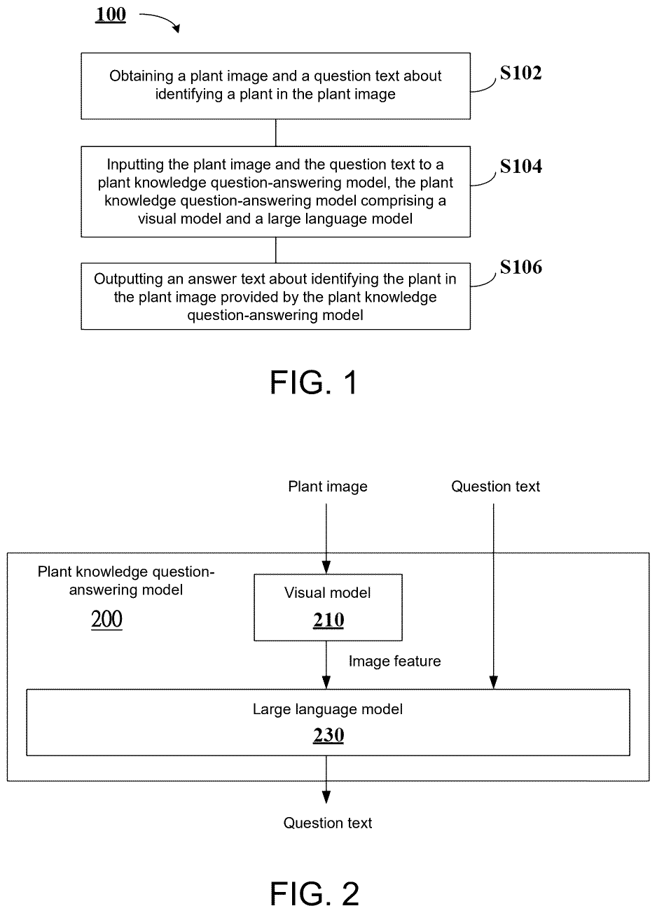

FIG. 1 shows a flowchart of a plant identification method 100 (hereinafter referred to as method 100) according to some embodiments of the present disclosure. As shown in FIG. 1, the method 100 includes step S102 to step S106.

In step S102, a plant image and a question text about identifying a plant in the plant image are obtained.

In step S104, the plant image and the question text are input to a plant knowledge question-answering model, the plant knowledge question-answering model includes a visual model and a large language model. As a non-limiting embodiment, the plant knowledge question-answering model may be a multimodal large language model.

In step S106, the answer text about identifying the plant in the plant image provided by the plant knowledge question-answering model is output.

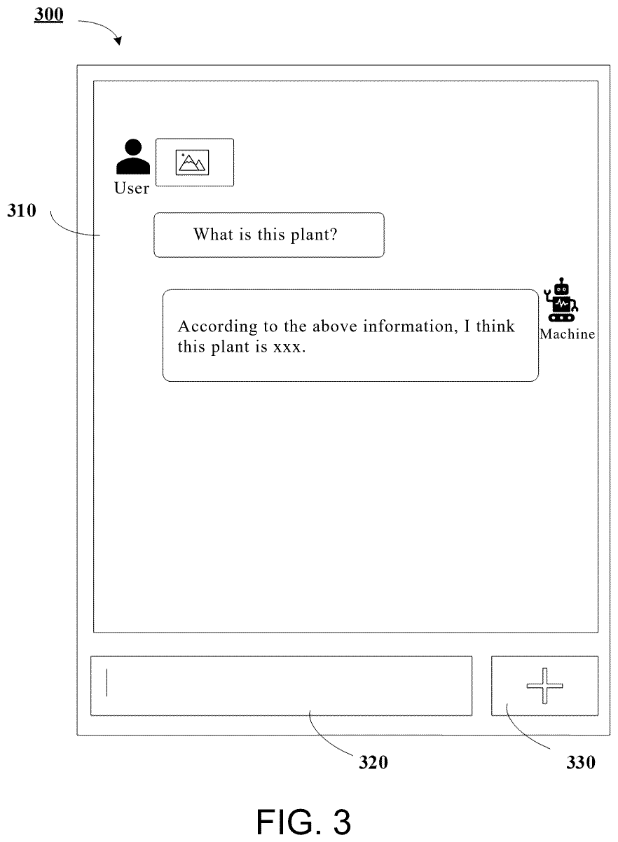

Specifically, identifying the plant in the plant image may include, for example, identifying the type and/or disease of the plant in the plant image. Correspondingly, the obtained question text may include question text about identifying the type and/or disease of the plant in the plant image. As a non-limiting example, a user interface 300 as shown in FIG. 3 may be provided. The user interface 300 includes a dialog box 310, a text input box 320, and an image adding button 330. The image adding button 330 is provided for receiving the plant image, and the text input box 320 is provided for receiving the question text.

The plant knowledge question-answering model used in the method 100 may be trained using multimodal data, the multimodal data includes plant images, questions about identifying the plant in the plant images, and answers to the questions. In order to identify the type of plants in the plant images, the multimodal data for training the plant knowledge question-answering model may include plant images, questions inquiring about the type of plants in the plant images, and answers indicating the type of plants in the plant images, for example {<plant image.jpg>, “What is this plant”, “This plant is Ficus hispida”}. In order to identify diseases of the plants in the plant images, the multimodal data for training the plant knowledge question-answering model may include plant images, questions inquiring about the diseases of the plants in the plant images, and answers indicating the diseases of the plants in the plant images, for example {<plant image.jpg>, “What is wrong with this plant”, “This plant is affected with leaf mold disease”}.

In the multimodal data provided for training the plant knowledge question-answering model, the plant images and the questions may serve as training samples, while the answers to the questions may serve as annotations of the samples. During the training process, the plant knowledge question-answering model learns how to understand relationships between images and text, and how to generate answers related thereto. By performing joint training on different modal data such as images and text, the plant knowledge question-answering model may learn the correspondence between different modalities, thereby achieving cross-modal information expression and reasoning capabilities. Through training data specific to the plant identification domain, plant identification capabilities are injected into the model.

FIG. 2 shows a schematic block diagram of a plant knowledge question-answering model 200 according to some embodiments of the present disclosure. As shown in FIG. 2, the plant knowledge question-answering model 200 includes a visual model 210 and a large language model 230. The visual model 210 is configured to receive a plant image to extract image features of the plant image. The large language model 230 is configured to receive the image features and question text to identify the plant in the plant image, thereby outputting answer text about identifying the plant in the plant image.

The large language model 230 is provided for further pre-training based on a synthesized corpus generated from a plant domain corpus on the basis of being pre-trained. Compared with directly pre-training the large language model 230 on a small-scale plant domain corpus, pre-training the large language model 230 on a larger-scale and more diversified synthesized corpus may enable the large language model 230 to more efficiently obtain knowledge from the synthesized corpus and learn the associations between knowledge points, thereby better improving the performance of the large language model 230 in the plant domain.

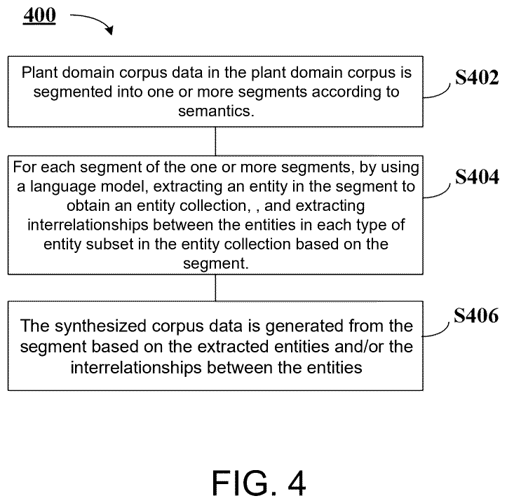

The synthesized corpus may be generated based on the plant domain corpus. In some examples, tens of thousands of books in the plant domain may be obtained and these books may be parsed to obtain text content, thereby forming the plant domain corpus. Referring to FIG. 4, FIG. 4 shows a flowchart of an operation 400 for generating the synthesized corpus according to some embodiments of the present disclosure. As shown in FIG. 4, the operation 400 may include steps S402 to S406.

At step S402, plant domain corpus data in the plant domain corpus is segmented into one or more segments according to semantics. In some examples, segmenting the plant domain corpus data according to semantics may be subsequently completed by a language model provided to extract entities and entity relationships, may also be completed by other language models, or may be completed by experts.

At step S404, for each segment of the one or more segments obtained by segmentation, by using a language model, extracting an entity in the segment to obtain an entity collection, and extracting interrelationships between the entities in each type of entity subset in the entity collection based on the segment. For example, the language model may be Generative Pre-trained Transformer (GPT), etc. As a non-limiting embodiment, the entities may include one or more of plant types, symptoms, diseases, and causes of the diseases.

In some examples, assuming the entity collection includes N entities, and each type of entity subset includes n entities, then the entity collection may include C_{N}ⁿ types of entity subsets. For example, when the quantity of the entities included in each type of the entity subset is 2 (such entity subsets may be referred to as entity pairs), the entity collection may include C_{N}², i.e., (n−1)×n/2 types of entity subsets. In other examples, the quantity of entities included in each type of the entity subset may be 3 (such entity subsets may be referred to as entity triplets). Of course, the quantity of entities included in each type of the entity subset may be flexibly set according to actual requirements. Thus, by extracting the interrelationships between the entities in each type of the entity subset in the entity collection through multiple iterations, comprehensive coverage of different entity relationships is ensured, thereby maintaining the diversity of descriptions about text instances in the synthesized corpus data while reducing the repetition of the subsequently generated synthesized corpus data.

At step S406, the synthesized corpus data is generated from the segment based on the extracted entities and/or the interrelationships between the entities via the language model. In some embodiments, generating the synthesized corpus data from the segment based on the extracted entities and/or the interrelationships between the entities includes at least one of the following: for each type of the entity subset in the entity collection, generating rewritten content of the segment with each of the entities respectively in the entity subset as a focus as synthesized corpus data; or for each type of the entity subset in the entity collection, generating an analysis content about the interactions of various entities in the entity subset in the context of the segment as the synthesized corpus data.

In some embodiments, the operation 400 may further include: for each segment of the one or more segments, generating a summary and a title of the segment via the language model, wherein at least one of the rewritten content and the analysis content is generated based on at least one of the summary and the title. In some embodiments, at least one of the rewritten content and the analysis content is performed based on the summary of the segment rather than the segment itself. In some embodiments, at least one of the rewritten content and the analysis content is performed based on the summary of the segment as well as the segment itself. In some embodiments, at least one of the rewritten content and the analysis content may be required to include or embody the title of the segment. In some embodiments, generating the rewritten content of the segment with each of the entities in the entity subset as a focus may include generating the rewritten content of the segment based on the interaction between the entity and the title of the segment.

Thus, the synthesized corpus data generated based on the operation 400 may include a large number of text instances in different expression forms generated based on the original plant domain corpus data, facilitating training of the large language model.

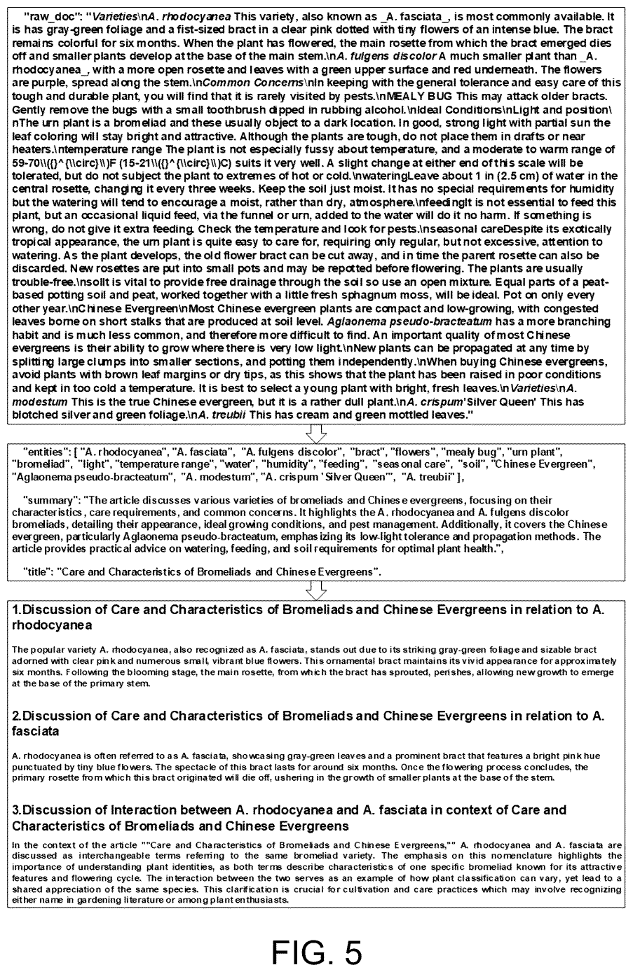

Referring to FIG. 5, FIG. 5 shows a non-limiting exemplary process of generating the synthesized corpus data based on the plant domain corpus data according to some embodiments of the present disclosure. A first box in FIG. 5 shows a segment of a plant domain corpus data “raw_doc”, then the language model is utilized to extract entities in the segment to obtain an entity collection “entities” and generate a summary “summary” and a title “title” of the segment. Next, taking the entity subset {“A. rhodocyanea”, “A. fasciata”} as an example, rewritten content 1 and 2 are generated respectively with “A. rhodocyanea” and “A. fasciata” in the entity subset as the focus, and an analysis content 3 is generated based on the interrelationship between them, so that the synthesized corpus data includes the rewritten content 1 and 2 as well as the analysis content 3.

Specifically, the rewritten content 1 corresponding to “A. rhodocyanea” also includes “Discussion of Care and Characteristics of Bromeliads and Chinese Evergreens in relation to “A. rhodocyanea” as a subtitle or a boundary line of the rewritten content 1, which includes “A. rhodocyanea” and the title “Care and Characteristics of Bromeliads and Chinese Evergreens”. The rewritten content 2 corresponding to “A. fasciata” also includes “Discussion of Care and Characteristics of Bromeliads and Chinese Evergreens in relation to A. fasciata” as a subtitle or a boundary line of the rewritten content 2, which includes “A. fasciata” and the above title. Additionally, the analysis content 3 corresponding to the interrelationship between “A. rhodocyanea” and “A. fasciata” also includes “Discussion of Interaction between A. rhodocyanea and A. fasciata in context of Care and Characteristics of Bromeliads and Chinese Evergreens” as a subtitle or a boundary line of the analysis content 3, which includes “A. rhodocyanea”, “A. fasciata” and the above title. Using subtitles or boundary lines to segment the large amount of generated text examples may enable the synthesized corpus data to be more organized.

In some embodiments, the synthesized corpus may include a mix of the plant domain corpus data and the synthesized corpus data, thereby focusing more on improving the plant identification performance of the plant knowledge question-answering model 200. That is to say, the plant domain corpus itself provided for generating the synthesized corpus may be incorporated into the synthesized corpus.

In some embodiments, the synthesized corpus may include a mix of general domain corpus data and the synthesized corpus data, enabling the enhancement of the generalization of the plant knowledge question-answering model 200 while improving the plant identification performance of the plant knowledge question-answering model 200.

In some further embodiments, the quantity of the general domain corpus data is in a preset ratio to the quantity of the synthesized corpus data. In some examples, the preset ratio may be determined via the following operations: training the large language model using the general domain corpus data and the synthesized corpus data mixed according to different ratios respectively as training data, and using validation data to determine a validation loss of the trained large language model; and selecting a ratio from these different ratios as the preset ratio based on the validation loss. For example, a ratio corresponding to the minimum validation loss may be selected as the preset ratio. In addition, in some examples, the validation data may be the general domain corpus data or the synthesized corpus data not used as the training data.

Given that the mixture ratio of the training data significantly impacts the final performance of the large language model, it is advisable to optimize the mixture ratio of the quantity of the general corpus data to the quantity of the synthesized corpus data based on preliminary small-scale training. This optimized mixture ratio should then be employed in subsequent large-scale training. By doing so, it is possible to ensure superior training results while simultaneously reducing training costs.

In some embodiments, the synthesized corpus may include a mix of the plant domain corpus data, the synthesized corpus data, and the general domain corpus data.

The visual capabilities of the large language model 230 may primarily depend on the visual model 210, particularly the image features extracted by the visual model 210. Consequently, the expressive ability of the image features of the visual model 210 will directly impact the performance of the large language model in plant identification visual tasks.

The visual model 210 may be established based on various suitable neural network architectures. In some embodiments, the visual model 210 may be a CLIP model. The CLIP model is a deep learning model designed to achieve interaction between natural language processing and computer vision.

In order to improve the performance of the visual model 210 in the plant identification field, in some embodiments, the CLIP model is trained using an image-text pair dataset via contrastive learning. For example, the CLIP model may first be trained separately using the image-text pair dataset via contrastive learning, and then jointly trained with the large language model that has undergone pre-training and further pre-training using the multimodal data. In this way, it is helpful to improve the overall performance of the model. Of course, the CLIP model may also be pre-trained separately first, and then when the plant knowledge question-answering model is trained using the multimodal data, the parameters of the CLIP model are fixed while only the parameters of the large language model are updated, which may expedite the training speed and reduce the computational and storage resources consumed by training.

It is understandable that a similar approach applies to other multimodal data. For instance, if audio data needs to be processed, the plant knowledge question-answering model may be provided through a large language model designed for handling audio, image, and textual features. This may be achieved either independently or in conjunction with a visual model for extracting image features and an auditory model for extracting audio features, or by combining one or both of these models.

In some embodiments, the image-text pair dataset includes plant domain image-text pairs and general domain image-text pairs. In some embodiments, the quantity of the plant domain image-text pairs is in a preset ratio to the quantity of the general domain image-text pairs. In some examples, the ratio of the quantity of the plant domain image-text pairs to the quantity of the general domain image-text pairs is 1:1. In this way, on the basis of retaining the general visual encoding capability of the CLIP model, the observation capability of the CLIP model for plant details is improved, so as to capture relevant information of plants from visual signals (e.g., images), so that the subsequent large language model has the ability to observe and comprehend both the overall and detailed aspects of visual information.

In addition, as a non-limiting embodiment, in order to identify the type of the plant in the plant image, the plant domain image-text pair may include at least one of a pair consisting of the plant image and a Latin name of the plant, and a pair consisting of the plant image and a plant feature tag collection. In order to identify the disease of the plant in the plant image, the plant domain image-text pair may include at least one of a pair consisting of the plant image and a plant disease name, and a pair consisting of the plant image and a disease feature tag collection.

The CLIP model employs a contrastive learning approach to map images and text into a shared embedding space. This approach ensures that the embedding vectors of corresponding image-text pairs are positioned closer together within this space, while those of unrelated image-text pairs are positioned farther apart. Through training, the CLIP model is capable of learning a common embedding space that effectively aligns images and text semantically, thereby enabling the extraction of cross-modal visual representations for images.

The training process of the CLIP model based on contrastive learning of image-text pair datasets is shown as an example below.

For the image-text pairs input into the CLIP model, it is first necessary to convert these different types of data into feature representations compatible with the internal processes of the model, thereby enabling subsequent handling of these disparate data types. This task is typically accomplished by encoders corresponding to the different modalities. Specifically, an image encoder of the CLIP model, such as a Convolutional Neural Network (CNN) or a Recurrent Neural Network (RNN), extracts image features from the image. Concurrently, a text encoder of the CLIP model, such as a Word2Vec model or a Bag of Words (BoW) model, extracts text features from the text.

Assuming a training batch consists of N image-text pairs, the image encoder extracts N image features, and the text encoder similarly extracts N text features. By pairing the N image features with the N text features, a total of N² samples may be formed. During the extraction of the image features by the image encoder and the text features by the text encoder, normalization may be applied to both of the image features and the text features independently. For each of the image features, there is one positive sample and (N−1) negative samples; correspondingly, for each of the text features, there is one positive sample and (N−1) negative samples. In total, there are N positive samples and (N²−N) negative samples.

The training objective of the CLIP model may be to maximize the similarity of the N positive samples (for example, a cosine similarity between the text features and the image features may be directly calculated) and/or minimize a similarity of the (N²−N) negative samples. For example, f(iᵢ) is a normalized i-th image feature, g(tⱼ) is a normalized j-th text feature, and a cosine similarity between the image feature f(iᵢ) and the text feature g(tⱼ) is sᵢⱼ= [symbol] (f(iᵢ), g(tⱼ) [symbol] , i.e., sᵢⱼ is a dot product of f(iᵢ) and g(tⱼ). Therefore, a similarity between the N image features and the N text features is S={sᵢⱼ= [symbol] f(iᵢ)·g(tⱼ) [symbol] }.

A temperature parameter greater than zero may also be introduced to control a smoothness of a softmax (normalized exponential function) distribution. A smaller temperature parameter makes the softmax distribution sharper, causing the CLIP model to focus more on matching positive samples. Additionally, the temperature parameter is typically a learnable parameter. Thus, a loss function

$$ℒ = \frac{1}{N} {\sum }_{i = 1}^{N} [ - log \frac{exp ( \frac{{s}_{i i}}{τ} )}{{\sum }_{j = 1}^{N} exp ( \frac{{s}_{i j}}{τ} )} - log \frac{exp ( \frac{{s}_{i i}}{τ} )}{{\sum }_{j = 1}^{N} exp ( \frac{{s}_{j i}}{τ} )} ]$$

may be used to calculate a loss of a current training batch. Here, an exp function is an exponential function with a real number e as the base, τ is a temperature parameter, and sᵢᵢ and sⱼᵢ represent similarity scores or compatibility scores. Specifically, sᵢᵢ represents a similarity score between a sample i and a positive sample thereof and may be used to represent a similarity between samples of the same type, and sⱼᵢ represents a similarity score between the sample i and other samples j and may be used to calculate a similarity between the sample i and all other samples. These similarity scores are used to calculate probability distributions via exponential functions and normalization steps (example softmax), thereby enabling comparison of similarities between different samples.

During the training process, the CLIP model may also calculate gradients via backpropagation and use an optimizer (for example, Adam optimizer) to update parameters of the image encoder and the text encoder as well as the temperature parameter.

Through contrastive learning, the expressive capability of visual features in the CLIP model may be enhanced, thereby improving the performance of the large language model on visual tasks, ultimately enhancing the plant identification ability of the entire plant knowledge question-answering model.

In some embodiments, the answer text includes symptoms of plants, and the answer text also includes one or more of the following: causes of the symptoms, methods for addressing the symptoms, and suggestions for the maintenance of the plants.

Upon obtaining the answer text, tasks associated with the content of the answer text may be generated and displayed to the user. In cases where there is a device connected that is capable of executing tasks, the corresponding device may also be automatically controlled to perform the tasks.

Specifically, in some embodiments, the method 100 may include: generating a maintenance plan based on the answer text, the maintenance plan including one or more pairs, each pair of the one or more pairs including one or more maintenance tasks and an identifier of a maintenance device for executing the one or more maintenance tasks; outputting the maintenance plan.

The maintenance plan may include a daily maintenance plan, a treatment maintenance plan, etc., or a combination thereof. For example, when the answer text does not involve a disease of the plant, the daily maintenance plan for the plant may be output. When the answer text involves a disease of the plant, the treatment maintenance plan for the plant may be output, and optionally a corresponding daily maintenance plan may also be output.

For illustrative purposes, a non-restrictive exemplary application of the method 100 may involve a diagnosis of diseases in tomato plants cultivated by a user. In this example, the foliage and fruits of tomato plants depicted in a plant image input by the user begin to show signs of decay. To further assist the user in maintaining the tomato plant, maintenance tasks may be generated based on the answer text. After generating the maintenance tasks from the answer text, and given that an identifier of a maintenance device, which is coupled to communicate with a user's terminal, is stored in a relevant database, it is possible to determine the identifier of the maintenance device associated with the tasks from the database according to the maintenance tasks, thereby generating a maintenance plan. Once the maintenance plan is obtained, the maintenance plan may be displayed on a user interface. Consequently, the user may ascertain which maintenance device (such as irrigation devices, fertilization devices, pruning devices, medication devices, light control devices, temperature control devices, humidity control devices, or combinations thereof) should be utilized, and what kind of maintenance tasks should be executed to care for the tomato plant. The maintenance tasks may include, for example, watering, misting, fertilizing, pruning, weeding, pot rotation, sun exposure, shading, temperature regulation, humidity regulation, pesticide application, and fungicide application. Specifically, the maintenance tasks may also encompass various parameters of the tasks, such as the timing, intervals, and quantity of watering, the dosage, timing, and intervals of fertilization, pruning locations, and the dosage and location of pesticide spraying, among others.

In some embodiments, the method 100 may include: controlling a corresponding maintenance device to complete the one or more maintenance tasks in the pair according to the identifier of the maintenance device in each pair of the one or more pairs in the maintenance plan.

Given that the maintenance device typically possess communication capabilities, commands may be transmitted to the maintenance device (for instance, via Bluetooth protocol, Zigbee protocol, etc.). For example, in the scenario described above, the maintenance plan may include two pairs: {fruit pruning task and leaf pruning task, identifier of the pruning device} and {pesticide spraying task, identifier of the dispensing device}. Commands indicating the execution of pruning tasks and spraying tasks are sent to the corresponding pruning and spraying devices based on their identifiers. This control allows the pruning and spraying devices to autonomously complete the pruning and spraying tasks, thereby reducing the user's maintenance burden and enhancing maintenance efficiency.

In addition to the automatic execution of the maintenance plan, in some embodiments, following the display of the maintenance plan, the user may be further queried to confirm the execution of the maintenance plan. Upon user confirmation of the execution of the maintenance plan, the corresponding maintenance device is controlled in accordance with the maintenance plan to complete the respective maintenance tasks.

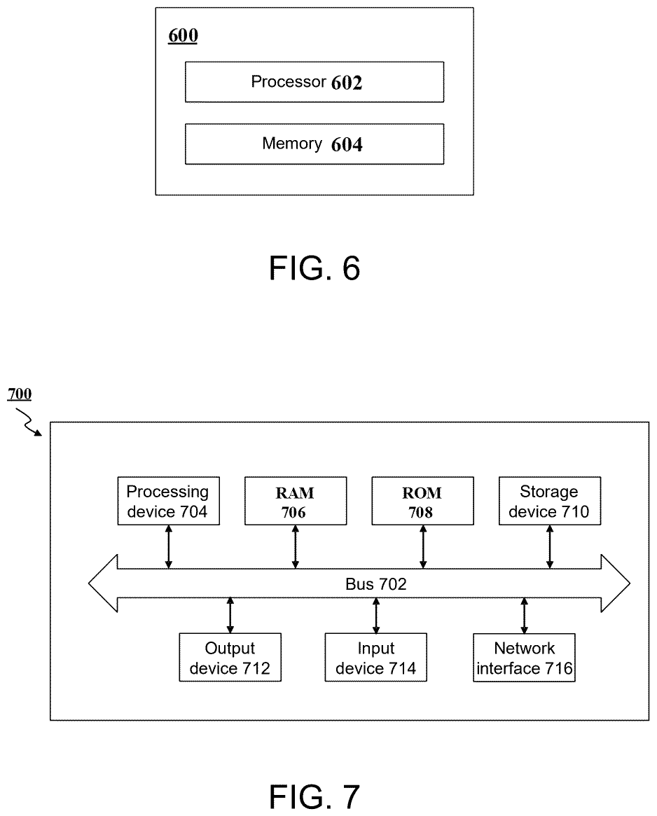

The present disclosure also provides an electronic device in another aspect. Referring to FIG. 6, FIG. 6 shows a schematic block diagram of an electronic device 600 according to some embodiments of the present disclosure. As shown in FIG. 6, the electronic device 600 includes a processor 602 and a memory 604 storing computer-executable instructions, which, when executed by the processor 602, enable the processor 602 to execute the plant identification method according to any of the foregoing embodiments of the present disclosure. The processor 602 may be, for example, a central processing unit (CPU) of the electronic device 600. The processor 602 may be any type of general-purpose processor, or may be a processor specifically designed for plant identification, such as an application-specific integrated circuit (“ASIC”). The memory 604 may be coupled to the processor 602 and may include various computer-readable media accessible by the processor 602. In various embodiments, the memory 604 described herein may include volatile and non-volatile media, removable and non-removable media. For example, the memory 604 may include any combination of the following: a random access memory (“RAM”), a dynamic RAM (“DRAM”), a static RAM (“SRAM”), a read-only memory (“ROM”), a flash memory, a cache memory, and/or any other type of non-transitory computer-readable medium. The memory 604 may store instructions that, when executed by the processor 602, enable the processor 602 to execute the method 100 according to any of the foregoing embodiments of the present disclosure.

In some embodiments, the electronic device 600 may be implemented as a smartphone, a smart tablet, a smart camera, a computer, etc.

The electronic device 600 is configured to execute the method 100 described in any of the foregoing embodiments, therefore reference may be made to the descriptions of various embodiments of the method 100 above, which will not be repeated here.

The present disclosure also provides a non-transitory storage medium having computer-executable instructions stored thereon, wherein the computer-executable instructions, when executed by a computer, enable the computer to execute the plant identification method according to any of the foregoing embodiments of the present disclosure.

The present disclosure also provides a computer program product, which may include instructions that, when executed by a processor, may implement the plant identification method according to any of the foregoing embodiments of the present disclosure. The instructions may be any instruction set to be executed directly by one or more processors, such as a machine code, or any instruction set to be executed indirectly, such as scripts. The instructions may be stored in object code format for direct processing by one or more processors, or stored in any other computer language, including scripts or collections of independent source code modules that are interpreted on demand or compiled ahead of time.

FIG. 7 shows a schematic block diagram of a computer system 700 on which embodiments of the present disclosure may be implemented. The computer system 700 includes a bus 702 or other communication mechanism for transmitting information, and a processing device 704 coupled to the bus 702 for processing information. The computer system 700 also includes a memory 706 coupled to the bus 702 for storing instructions to be executed by the processing device 704, and the memory 706 may be a random access memory (RAM) or other dynamic storage device. The memory 706 may also be provided for storing temporary variables or other intermediate information during execution of instructions to be executed by the processing device 704. The computer system 700 also includes a read-only memory (ROM) 708 or other static storage device coupled to the bus 702 for storing static information and instructions for the processing device 704. A storage device 710 such as a magnetic disk or optical disk is provided and coupled to the bus 702 for storing information and instructions. The computer system 700 may be coupled via the bus 702 to an output device 712 for providing outputs to a user, such as but not limited to a display (such as a cathode ray tube (CRT) or liquid crystal display (LCD)), a speaker, etc. An input device 714 such as a keyboard, a mouse, a microphone, etc. is coupled to the bus 702 for transmitting information and command selections to the processing device 704. The computer system 700 may execute embodiments of the present disclosure. Consistent with some embodiments of the present disclosure, results are provided by the computer system 700 in response to the processing device 704 executing one or more sequences of one or more instructions contained in the memory 706. Such instructions may be read into the memory 706 from another computer-readable medium such as the storage device 710. Execution of the sequences of instructions contained in the memory 706 enables the processing device 704 to execute the methods described herein. Alternatively, hardwired circuitry may be used in place of or in combination with software instructions to implement the present teachings. Thus, embodiments of the present disclosure are not limited to any specific combination of hardware circuitry and software. In various embodiments, the computer system 700 may be connected to one or more other computer systems, similar to the computer system 700, across a network via a network interface 716, thereby forming a networked system. This network may include a private network or a public network, such as the Internet. In such a networked system, one or more computer systems may store data and provide the data to other computer systems. The term “computer-readable medium” as used herein refers to any medium that participates in providing instructions to the processing device 704 for execution. This medium can take many forms, including but not limited to non-volatile media, volatile media, and transmission media. Non-volatile media include, for example, optical or magnetic disks, such as the storage device 710. Volatile media include a dynamic memory, such as the memory 706. Transmission media include coaxial cables, copper wires, and fiber optics, including the wiring containing the bus 702. Common forms of computer-readable media or computer program products include, for example, floppy disks, flexible disks, hard disks, magnetic tapes, or any other magnetic media, CD-ROMs, digital video disks (DVDs), Blu-ray disks, any other optical media, thumb drives, memory cards, RAM, PROM and EPROM, flash EPROM, any other memory chip or cartridge, or any other tangible medium from which a computer can read. Various forms of computer-readable media may be involved in carrying one or more sequences of one or more instructions to the processing device 704 for execution. For instance, instructions might initially be carried on a disk of a remote computer. The remote computer may load the instructions into its dynamic memory and send the instructions over a telephone line using a modem. A local modem of the computer system 700 may receive the data on the telephone line and use an infrared transmitter to convert the data into an infrared signal. An infrared detector coupled to the bus 702 may receive the data carried in the infrared signal and place the data on the bus 702. The bus 702 carries the data to the memory 706, from which the processing device 704 retrieves and executes the instructions. For example, instructions received by the memory 706 may be stored in the storage device 710 before or after being executed by the processing device 704.

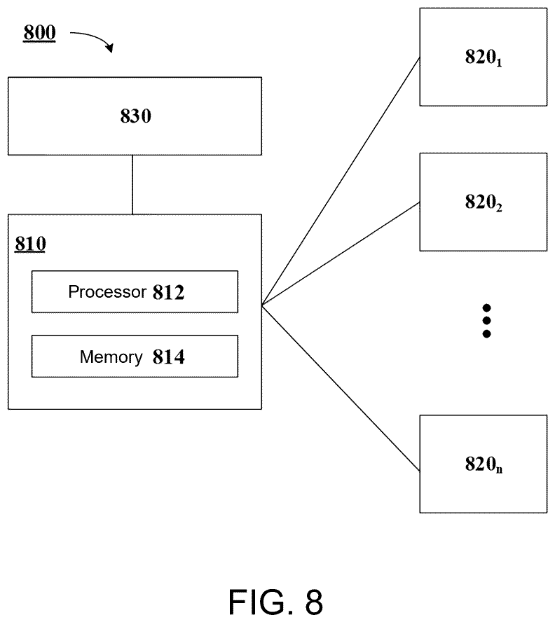

FIG. 8 shows a schematic block diagram of a maintenance system 800 according to some embodiments of the present disclosure. The maintenance system 800 include an electronic device 810, which include a processor 812 and a memory 814 coupled to the processor 812 and storing instructions. The electronic device 810 may be implemented in the form of, but not limited to, the aforementioned electronic device 600 or the computer system 700, and may be realized as, for example but not limited to, a smartphone, a smart tablet, a smart camera, a computer, etc. The memory 814 may store instructions that, when executed by the processor 812, enable the processor 812 to perform the plant identification method according to any of the embodiments disclosed herein. The maintenance system 800 also includes one or more maintenance devices (e.g., 820₁, 820₂, . . . , 820ₙ) communicatively coupled with the electronic device 810, which are configured to perform maintenance tasks in response to receiving commands from the electronic device 810.

Specifically, in some embodiments, the instructions stored in the memory 814, when executed by the processor 812, may enable the processor 812 to: obtain the plant image and the question text about identifying the plant in the plant image; input the plant image and the question text to the plant knowledge question-answering model, the plant knowledge question-answering model including the visual model and the large language model, wherein the visual model is configured to receive the plant image to extract image features of the plant image, the large language model is configured to receive the image features and the question text to identify the plant in the plant image, the large language model is provided for further pre-training using the synthesized corpus generated based on the plant domain corpus on the basis of being pre-trained, the plant knowledge question-answering model is trained using the multimodal data, the multimodal data includes plant images, questions about identifying the plant in the plant images, and answers to the questions; generate the answer text about identifying the plant in the plant image provided by the plant knowledge question-answering model; generate the maintenance plan based on the answer text, the maintenance plan including one or more pairs, each pair of the one or more pairs including one or more maintenance tasks and the identifier of the maintenance device for executing the one or more maintenance tasks; and transmit the command to the corresponding maintenance device (e.g., 820₁, 820₂, . . . , 820ₙ) according to the identifier of the maintenance device in each pair of the one or more pairs in the maintenance plan to control the corresponding maintenance device (e.g., 820₁, 820₂, . . . , 820ₙ) to complete the one or more maintenance tasks in the pair.

In some embodiments, the electronic device 810 includes a user interface (not shown). For example, the answer text may be displayed on the user interface, and/or the maintenance plan may be displayed on the user interface.

In some embodiments, the maintenance system 800 may include a camera 830 communicatively coupled with the electronic device 810. The camera 830 may be any suitable imaging device for monitoring a target plant. The target plant may be positioned in a field of view of the camera 830. The camera 830 may be configured to capture a plant image and transmit the captured plant image to the electronic device 810. Accordingly, the instructions stored in the memory 814 may include instructions that, when executed by the processor 812, enable the processor 812 to execute the following operations: outputting the answer text based on the plant image received from the camera 830 and a default question text about identifying the plant in the plant image.

In some examples, the default question text may include question text about identifying the type and/or disease of the plant in the plant image. For example, the default question text may be stored in a related database, such that in response to the plant image captured by the camera, the default question text may be extracted from the database. The database may also store the name of the plant, maintenance information of the plant, diseases of the plant, and corresponding treatment and prevention methods, etc. Such information about the plant may be stored in the database in association with image features of the plant. Information may be extracted based on a matching degree between the image features of the identified plant image and the image features of the plant stored in the database, for example, under the circumstances where the matching degree falls within a preset range. As a non-limiting example, a cosine similarity between a first vector representing the image features of the identified plant image and a second vector representing the image features of the plant stored in the database may be calculated. When the calculated cosine similarity is greater than a preset threshold, the image features of the identified plant image are considered to match the image features of the plant stored in the database, and information stored in the database in association with the matched image features is extracted as the default question text.

In some examples, the plant image received from the camera 830 may be input into the aforementioned plant knowledge question-answering model for processing. For example, close-up images or videos of one or more feature parts of the target plant may be required, in which case the user may not need to input these close-up images or videos, but rather the camera 830 automatically obtains these close-up images or videos. Alternatively, when the plant image from the user cannot be identified due to various reasons such as insufficient clarity, the user may not need to re-input the plant image, but rather the camera 830 automatically captures the plant image. That is to say, the plant image captured by the camera 830 may be used to assist in generating the answer text.

Thus, the answer text may be autonomously generated using the image captured by the camera 830, and the maintenance plan may be automatically executed, so as to achieve fully automatic monitoring and maintain of the target plant.

Various embodiments of the maintenance system 800 may be similar to any embodiment of the foregoing aspects of the present disclosure, and will not be described in detail herein.

The above describes one or more exemplary embodiments of the present disclosure. Other embodiments are within the scope of the appended claims. In some cases, the actions or steps recited in the claims may be executed in an order different from that in the embodiments and may still achieve desired results. Additionally, the processes depicted in the accompanying drawings do not necessarily require the specific order or sequential order shown to achieve desired results. In some embodiments, multitasking and parallel processing are also possible or may be advantageous.

The system, device, module or unit illustrated in the above embodiments may be specifically implemented by a computer chip or entity, or by a product having a specific function. A typical implementation device is a server system. Of course, the present disclosure does not exclude that with the development of computer technology in the future, the computer implementing the functions of the above embodiments may be, for example, a personal computer, a laptop computer, a vehicle-mounted human-machine interaction device, a cellular phone, a camera phone, a smart phone, a personal digital assistant, a media player, a game console, a tablet computer, a wearable device, or any combination thereof.

The terms “include”, “comprise” or any other variations thereof are intended to cover non-exclusive inclusion, so that a process, method, product or device including a series of elements includes not only those elements, but also other elements not explicitly listed, or also includes elements inherent to such process, method, product or device. Without further limitation, it is not excluded that there are additional identical or equivalent elements in the process, method, product or device including the elements. For example, words such as “first”, “second” are used to indicate names and do not indicate any particular order.

For convenience of description, when describing the above device, it is described separately by dividing into various modules according to functions. Of course, when implementing one or more embodiments of the present disclosure, the functions of each module may be implemented in one or more pieces of software and/or hardware, or a module implementing the same function may be implemented by a combination of multiple sub-modules or sub-units, etc. The device embodiments described above are merely illustrative, for example, the division of the units is merely a division of logical functions, and there may be other division methods in actual implementation, for example, multiple units or components may be combined or may be integrated into another system, or some features may be ignored or not executed. Furthermore, the coupling or direct coupling or communication connection displayed or discussed between one another may be an indirect coupling or communication connection through some interfaces, devices, or units, and may be electrical, mechanical, or of another form.

The present disclosure is described with reference to flowcharts and/or block diagrams of methods, device (systems), and computer program products according to embodiments of the present disclosure. It should be understood that each flow and/or block in the flowcharts and/or block diagrams, as well as combinations of flows and/or blocks in the flowcharts and/or block diagrams, may be implemented by computer program instructions. These computer program instructions may be provided to a processor of a general-purpose computer, a special-purpose computer, an embedded processor, or other programmable data processing apparatus to produce a machine, such that the instructions executed by the processor of the computer or other programmable data processing apparatus create means for implementing the functions specified in one or more flows of the flowcharts and/or one or more blocks of the block diagrams.

These computer program instructions may also be stored in a computer-readable storage medium capable of directing a computer or other programmable data processing apparatus to operate in a specific manner, such that the instructions stored in the computer-readable storage medium produce an article of manufacture that includes instruction means for implementing the functions specified in one or more processes of a flowchart and/or one or more blocks of a block diagram. These computer program instructions may also be loaded onto a computer or other programmable data processing apparatus to cause a series of operational steps to be performed on the computer or other programmable apparatus, thereby generating a computer-implemented process so that the instructions executed on the computer or other programmable apparatus provide steps for implementing the functions specified in one or more processes of a flowchart and/or one or more blocks of a block diagram.

Those skilled in the art should understand that one or more embodiments of the present disclosure may be implemented in the form of entirely hardware embodiments, entirely software embodiments, or embodiments that combine both software and hardware aspects. Moreover, one or more embodiments of the present disclosure may take the form of a computer program product implemented on one or more computer-usable storage media containing computer-usable program code, including but not limited to, a disk storage, a CD-ROM, an optical storage, and the like.

One or more embodiments of the present disclosure may be described in the general context of computer-executable instructions executed by a computer, such as program modules. Generally, program modules include routines, programs, objects, components, data structures, and the like, that perform particular tasks or implement particular abstract data types. One or more embodiments of the present disclosure may also be practiced in distributed computing environments where tasks are performed by remote processing devices linked through a communications network. In distributed computing environments, program modules may be located in local and remote computer storage media, including storage devices.

In the present disclosure, parts that are the same or similar between various embodiments can be cross-referenced, with each embodiment emphasizing differences from other embodiments. In particular, for device embodiments, since they are fundamentally similar to method embodiments, the description is relatively simple, and relevant portions can be referenced in the description of the method embodiments. In the description of this disclosure, references to terms such as “one embodiment,” “some embodiments,” “example,” “specific example,” or “exemplary” are intended to mean that the specific features, structures, materials, or characteristics described in connection with that embodiment or example are included in at least one embodiment or example of the present disclosure. In this disclosure, the illustrative expression of the above terms does not necessarily pertain to the same embodiment or example. Moreover, the described specific features, structures, materials, or characteristics can be suitably combined in any one or more embodiments or examples. Furthermore, without conflicting with one another, those skilled in the art may combine and integrate the different embodiments or examples described in this disclosure and the features of different embodiments or examples.

Furthermore, as used herein, the terms “herein,” “above,” “below,” “hereinafter,” “above-referenced,” and similar expressions shall refer to this disclosure as a whole and not to any particular section of this disclosure. Additionally, unless explicitly stated otherwise or as understood otherwise in the context in which it is used, conditional language such as “can,” “may,” “for example,” “such as,” and the like, as used herein, is generally intended to convey that some embodiments may include, while other embodiments may not include, some features, elements, and/or states. Therefore, such conditional language is not generally intended to imply that one or more embodiments require the presence of features, elements, and/or states in any way, or whether these features, elements, and/or states are included or executed in any particular embodiment.

The aforementioned description merely constitutes one or more embodiments of the present disclosure and is not intended to limit one or more embodiments of the present disclosure. Those skilled in the art will recognize that various modifications and variations can be made to one or more embodiments of this disclosure. Any modifications, equivalent substitutions, improvements, and the like, made within the spirit and principles of this disclosure, should be included within the scope of the claims.

What is claimed is:

1. A plant identification method, comprising:
obtaining a plant image and a question text about identifying a plant in the plant image;
inputting the plant image and the question text to a plant knowledge question-answering model, the plant knowledge question-answering model comprising a visual model and a large language model, wherein the visual model is configured to receive the plant image to extract image features of the plant image, the large language model is configured to receive the image features and the question text to identify the plant in the plant image, the large language model is provided for further pre-training using a synthesized corpus generated based on a plant domain corpus on a basis of being pre-trained, the plant knowledge question-answering model is trained using multimodal data, the multimodal data comprises plant images, questions about identifying the plant in the plant images, and answers to the questions; and
outputting an answer text about identifying the plant in the plant image provided by the plant knowledge question-answering model.

2. The plant identification method according to claim 1, wherein the synthesized corpus comprises a mix of plant domain corpus data and synthesized corpus data.

3. The plant identification method according to claim 1, wherein the synthesized corpus comprises a mix of general domain corpus data and synthesized corpus data.

4. The plant identification method according to claim 3, wherein a quantity of the general domain corpus data is in a preset ratio to a quantity of the synthesized corpus data, and the preset ratio is determined via following operations:
training the large language model using the general domain corpus data and the synthesized corpus data mixed according to different ratios respectively as training data, and using validation data to determine a validation loss of the trained large language model; and
selecting a ratio from the different ratios as the preset ratio based on the validation loss.

5. The plant identification method according to claim 1, wherein the synthesized corpus is constructed via following operations:
segmenting plant domain corpus data in the plant domain corpus into one or more segments according to semantics;
for each segment of the one or more segments, by using a language model, extracting an entity in the segment to obtain an entity collection, extracting interrelationships between entities in each type of entity subset in the entity collection based on the segment, and generating synthesized corpus data from the segment based on the extracted entities and/or the interrelationships between the entities.

6. The plant identification method according to claim 5, wherein generating the synthesized corpus data from the segment based on the extracted entities and/or the interrelationships between the entities comprises at least one of following:
for each type of the entity subset in the entity collection, generating a rewritten content of the segment with each of the entities respectively in the entity subset as a focus to serve as the synthesized corpus data; or
for each type of the entity subset in the entity collection, generating an analysis content about an interaction of each of the entities in the entity subset in a context of the segment to serve as the synthesized corpus data.

7. The plant identification method according to claim 6, wherein, for each segment of the one or more segments, a summary and a title of the segment are further generated via the language model, and wherein at least one of the rewritten content and the analysis content is generated based on at least one of the summary and the title.

8. The plant identification method according to claim 5, wherein a quantity of the entities comprised in each type of the entity subset is two or three.

9. The plant identification method according to claim 5, wherein the entities comprise one or more of plant types, symptoms, diseases, and causes of the diseases.

10. The plant identification method according to claim 1, wherein the visual model is a contrastive language-image pre-training (CLIP) model, and the CLIP model is trained on an image-text pair dataset through contrastive learning.

11. The plant identification method according to claim 10, wherein the CLIP model is first trained separately using an image-text pair dataset via contrastive learning, and then jointly trained with the multimodal data together with the large language model that has undergone the pre-training and the further pre-training.

12. The plant identification method according to claim 10, wherein the image-text pair dataset comprises plant domain image-text pairs and general domain image-text pairs, and a quantity of the plant domain image-text pairs is in a preset ratio to a quantity of the general domain image-text pairs.

13. The plant identification method according to claim 12, wherein the obtained question text comprises question text about identifying a type of the plant in the plant image, the multimodal data comprises the plant images, the questions inquiring about the type of the plant in the plant images, and the answers indicating the type of the plant in the plant images, the plant domain image-text pair comprises at least one of a pair consisting of the plant image and a Latin name of the plant, and a pair consisting of the plant image and a plant feature tag collection.

14. The plant identification method according to claim 12, wherein the obtained question text comprises question text about identifying a disease of the plant in the plant image, the multimodal data comprises the plant images, the questions inquiring about the disease of the plant in the plant images, and the answers indicating the disease of the plant in the plant images, the plant domain image-text pair comprises at least one of a pair consisting of the plant image and a plant disease name, and a pair consisting of the plant image and a disease feature tag collection.

15. The plant identification method according to claim 14, wherein the answer text comprises the disease of the plant, and the answer text further comprises one or more of causes of the disease, treatment methods for the disease, and maintenance suggestions for the plant.

16. The plant identification method according to claim 1, comprising:
generating a maintenance plan based on the answer text, wherein the maintenance plan comprises one or more pairs, each pair of the one or more pairs comprises one or more maintenance tasks and an identifier of a maintenance device for executing the one or more maintenance tasks; and
outputting the maintenance plan.

17. The plant identification method according to claim 16, comprising:
controlling the corresponding maintenance device to complete the one or more maintenance tasks in the pair based on the identifier of the maintenance device in each pair of the one or more pairs in the maintenance plan.

18. An electronic device, comprising:
a processor; and
a memory storing computer-executable instructions that, when executed by the processor, enable the processor to execute the plant identification method according to claim 1.

19. A non-transitory storage medium having computer-executable instructions stored therein, wherein the computer-executable instructions, when executed by a computer, enable the computer to execute the plant identification method according to claim 1.

20. A computer program product, the computer program product comprising instructions, the instructions, when executed by a processor, implementing the plant identification method according to claim 1.

21. A maintenance system, comprising:
an electronic device, the electronic device comprising a processor and a memory coupled to the processor and storing instructions, the instructions, when executed by the processor, enabling the processor to:
obtain a plant image and a question text about identifying a plant in the plant image,
input the plant image and the question text to a plant knowledge question-answering model, the plant knowledge question-answering model comprising a visual model and a large language model, wherein the visual model is configured to receive the plant image to extract image features of the plant image, the large language model is configured to receive the image features and the question text to identify the plant in the plant image, the large language model is provided for further pre-training using a synthesized corpus generated based on a plant domain corpus on a basis of being pre-trained, the plant knowledge question-answering model is trained using multimodal data, the multimodal data comprises plant images, questions about identifying the plant in the plant images, and answers to the questions,
generate an answer text about identifying the plant in the plant image provided by the plant knowledge question-answering model,
generate a maintenance plan based on the answer text, the maintenance plan comprising one or more pairs, each pair of the one or more pairs comprising one or more maintenance tasks and an identifier of a maintenance device for executing the one or more maintenance tasks, and
transmit a command to the corresponding maintenance device according to the identifier of the maintenance device in each pair of the one or more pairs in the maintenance plan to control the corresponding maintenance device to complete the one or more maintenance tasks in the pair; and
the maintenance device communicatively coupled to the electronic device, the maintenance device configured to execute the maintenance task in response to receiving the command from the electronic device.

22. The maintenance system according to claim 21, comprising:
a camera communicatively coupled with the electronic device, the camera being configured to capture the plant image and transmit the captured plant image to the electronic device,
wherein the instructions comprise instructions that, when executed by the processor, enable the processor to execute following operations:
outputting the answer text based on the plant image received from the camera and a default question text about identifying the plant in the plant image.

23. The maintenance system according to claim 22, wherein the default question text comprises question text about identifying a type and/or a disease of the plant in the plant image.
